(19) United States
(12) Patent Application Publication
(10) Pub. No.: US 2006/0209815 A1
(43) Pub. Date: Sep. 21, 2006

(54) Modular interlocking expandable construction system

(76) Inventors: Pablo Castro-Estevez, New York, NY (US); Jennifer Lee, New York, NY (US)

Correspondence Address: SHEARMAN & STERLING;INTELLECTUAL PROPERTY DOCKETING, 599 LEXINGTON AVENUE, NEW YORK, NY, 10022, US

(21) Appl. No.: 11/377,109

(22) Filed: Mar. 16, 2006

Related U.S. Application Data
(60) Provisional application No. 60/663,055, filed on Mar. 18, 2005.

(51) Int. Cl. H04L 12/50

(52) U.S. Cl. 370/379

(57) ABSTRACT

A system for modular construction which is comprised of a plurality of related structural units, each of which is slotted and interlocked to form an assembly requiring no tools or fasteners. The system provides infinite scalability employing a systematized gridlike formation. The units may be assembled, disassembled, and reassembled in a variety of configurations. Each structural unit comprises a planar piece having a plurality of parallel interlocking slots of specific length. Each unit is connected to additional unit pieces through interlocking slot connections wherein each unit is placed in perpendicular arrangement to other units and the slots interconnect to fit the units together. The assembled units exist in a grid-like pattern and establish planar boundaries in space. The boundaries defined by the assembly are expandable in all three dimensions based on the number and type of the different related units used.

This application hereby claims the benefit of previously filed and co-pending provisional application 60/663,055, filed on Mar. 18, 2005.

### BACKGROUND OF THE INVENTION

This invention relates generally to a scalable, modular construction assembled from a plurality of standardized structural units which are limited in variation but which can produce a variety of constructions having gridlike patterns. The standardized units have interlocking slots of a common length that are spaced apart based on a standardized spacing model. The assembly may be expanded in three dimensions, is structurally stable, and may find use in the field of partition systems or furniture systems.

### BRIEF SUMMARY OF THE INVENTION

The present invention comprises a plurality of related structural units, each of which is slotted and interlocked to form an assembly requiring no use of tools or fasteners. The units are sized and slotted based on a standardized spacing model. Three types of units are provided, although the invention may be practiced using only one or more of these unit types: a basic unit, a multiples unit, and a capping unit.

The basic unit contains one pair of in-line slots on each of two opposite sides of the unit. The length of each slot is identical and in a preferred embodiment measures one quarter of the length of the dimension in which the slot is provided. The multiples unit contains one or more additional pairs of in-line slots. The distance between every slot pair and any neighboring slot pairs is the same. Finally, the capping unit is a half-unit of the basic unit or a multiples unit. Each unit, whether a basic unit, a multiples unit, or a capping unit, is connected in a perpendicular orientation to at least two other units in the assembly. In a preferred embodiment, connections between units are perpendicular. Connection is by means of the interlocking slots. Use of only the basic units limits the shape of the assembly to that of a tower. Use of the multiples units in conjunction with basic units allows for the assembly of partitions or walls of expandable length, width, and height, as well as other modular structures. The capping units function as terminating pieces at the periphery of the assembly and effectively hide unused slots.

The units are planar and have a thickness sufficient to be self-supporting, given the material of construction employed. The slots have a width, i.e. opening, that matches the thickness of the units. Based on the slot length and width, when the units are fully interlocked, they fit snugly without obstructing each other in their assembly and meet end-to-end as they stack one on top of the other. The joints of the assembly, formed by the interlocked slots, are completely hidden from view and regularized in a grid-like pattern that is part of the assembly's appearance.

The assembly of this invention may be expanded in all three dimensions and constructed without the use of tools or fastening devices. The repeated structural units are combined in a vertical direction consistent with the direction of slots and slot joints thereby created. All units in the assembly are oriented in a planar direction that is consistent with the plane of the structural units or to a plane that is perpendicular or nearly perpendicular to that surface along the axis of the slot joints. In contrast to work in the prior art, whereby it is often the case that structural members are placed in horizontal relationship to vertical structural members and vice versa, in this invention all planar material is utilized in a consistent vertical direction allowing the construction and formation of a space defined by planar surfaces to distinguish a boundary of volume such as a partition wall of variable length, width and height. It is also a distinct advantage of the invention that the assembly of the structural units forms a geometry of elements based on a grid and which encloses space and thus demarcates space and can function as a divider or wall partition.

Without compromise to the structural integrity and stability of the assembly, the assembly may accommodate void openings of various geometries by means of cut-aways in each of the structural units.

Further disclosure related to the invention is provided in the drawings and in the detailed description that follows. The invention is not limited however to any particular embodiments described, and various modifications and alternative embodiments such as would occur to one skilled in the art to which this invention relates are also contemplated and included within the scope of the invention described and claimed herein.

### BRIEF DESCRIPTION OF THE DRAWINGS

FIG. 1A is exemplary of the basic structural unit of the invention with two pairs of in-line slots a fixed distance apart and having a slot length equal to one fourth of the unit's dimensional height. FIG. 1B depicts a perspective view of the basic structural unit shown in FIG. 1A.

FIG. 2A is exemplary of a multiples structural unit with an additional pair of in-line slots an equal fixed distance apart and of equal slot length. FIG. 2B depicts a perspective view of the multiples structural unit shown in FIG. 2A.

FIG. 3A is exemplary of a capping unit with unit dimensional height half the basic unit height, having two slots located a fixed distance apart and located along only one edge or side.

FIG. 3B depicts a perspective view of the capping unit piece shown in FIG. 3A.

FIG. 4A is exemplary of a capping unit with unit dimensional height half the basic unit height, having three equally-spaced slots located along only one edge or side. FIG. 4B depicts a perspective view of the capping unit piece shown in FIG. 4A.

FIG. 5 depicts the interlocking of interconnecting slots of one basic structural unit having two pairs of in-line slots to one multiples structural unit having three pairs of in-line slots. Both structural unit pieces have the same unit dimensional height

FIG. 6 depicts the interlocking of interconnecting slots of one basic structural unit having two pairs of in-line slots and one capping unit having two slots.

FIG. 7A depicts the relationship of interlocking units in a sample configuration comprised of basic structural units interconnected with capping units at both top and bottom ends of the assembly.

FIG. 7B depicts the assembled configuration of the sample units shown in FIG. 7A.

FIG. 8 depicts a sample configuration of assembled units of the invention.

FIG. 9 depicts a sample configuration of assembled units of the invention.

FIGS. 10A, 10B and 10C depict progressive stages in the assembly of a configuration of sample units wherein the units are interconnected to form a partition with a comer. FIG. 10D shows the assembled units at a representative height.

FIG. 11 is exemplary of an assembly of a sample configuration of units wherein the units are interconnected with an overall assembly width equal to the width of a multiples unit having six slots.

FIG. 12A is exemplary of an assembly of a sample configuration of units wherein a shorter height of units is interconnected to a taller height of units thereby creating a shelf assembly which can support a flat board or other material such as shown in FIG. 12B.

FIG. 13A is exemplary of an assembly of a sample configuration of units wherein areas of varying heights are interconnected to create shelf assemblies of varying dimensions which can support a flat board or other material such as shown in FIG. 13B.

FIG. 14A depicts a multiples structural unit having the same interlocking characteristics as the unit of FIG. 2A, but lacking cutaways between the pairs of in-line slots.

FIG. 14B depicts a perspective view of the basic structural unit shown in FIG. 14A.

FIG. 14C depicts a basic structural unit having the same interlocking characteristics as the unit of FIG. 1A, but lacking cutaways between the pairs of in-line slots.

FIG. 14D depicts a perspective view of the basic structural unit shown in FIG. 14C.

FIG. 14E depicts a capping unit having the same interlocking characteristics as the unit of FIG. 4A, but lacking a cutaway between the slots.

FIG. 14F depicts a perspective view of the capping unit piece shown in FIG. 14E.

FIG. 14G depicts a capping unit having the same interlocking characteristics as the unit of FIG. 3A, but lacking a cutaway between the slots.

FIG. 14H depicts a perspective view of the capping unit piece shown in FIG. 14G.

FIG. 15 is exemplary of an alternate embodiment of the sample configuration as shown in FIG. 7B, based on assembly of basic units illustrated in FIG. 14C and capping units illustrated in FIG. 14G.

FIG. 16 depicts an alternate embodiment of the sample configuration as shown in FIG. 8.

FIG. 17 depicts an alternate embodiment of the sample configuration as shown in FIG. 9.

### DETAILED DESCRIPTION

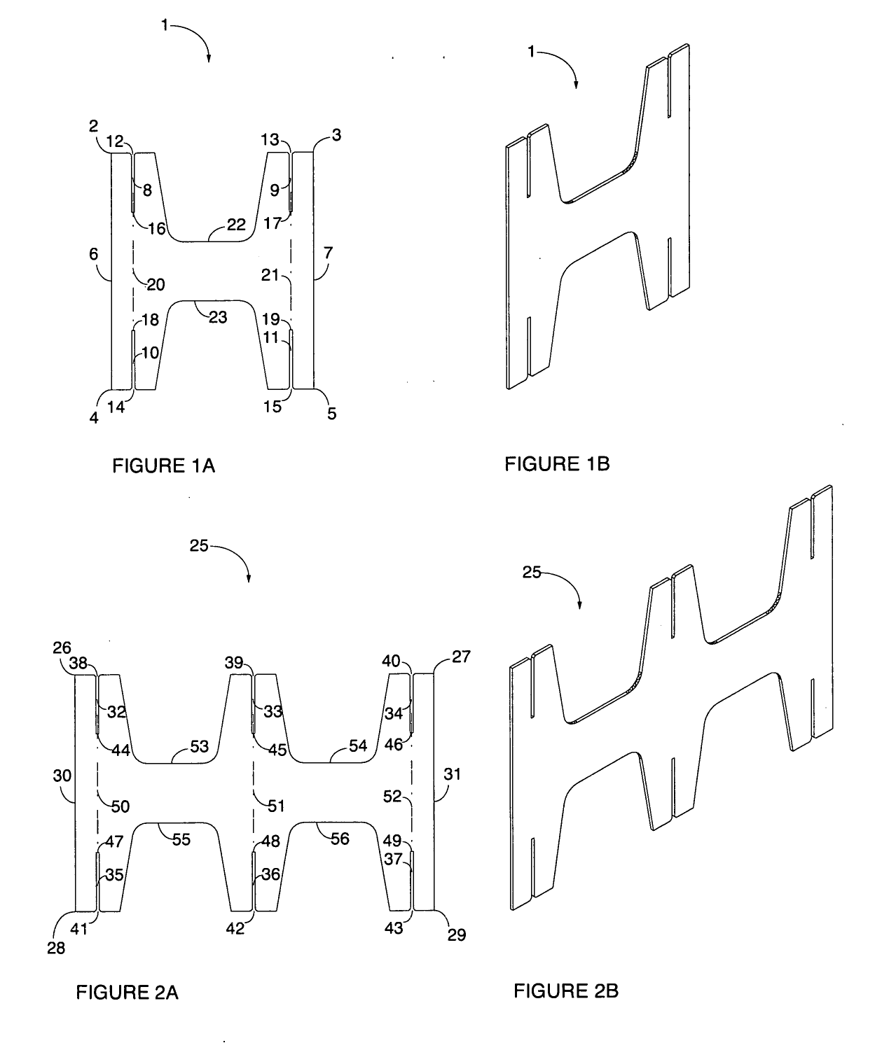

Referring now to the drawings, FIGS. 1A through 17 illustrate various embodiments of the apparatus of the invention. The basic unit of construction for the system is a structural member capable of being detachably connected slot-to-slot to one or more other structural members. The system comprises several distinct but geometrically related units: a basic unit, a multiples unit, and a capping unit. The invention may be practiced using one or more of these different unit types.

In the embodiments of the invention illustrated in FIGS. 1 through 13, a portion of the planar surface of the units is cut away in such a manner as to allow for the development of void openings in the assembly which permeate the wall or partition. Such openings function to allow light to pass through the wall or partition. Such cutaways may be open (as shown in FIG. 1A) or closed and may have any of a variety of shapes. The illustrated units are therefore representations of only a few of the many geometries possible in keeping with the scope and spirit of the present invention.

The structural units of the invention have a defined spacing between slots and a defined relationship between slot length and overall unit height. Slots exist only on two opposite sides of the basic and multiples units and only on one side of the capping units. It is also understood that the length and height of the unit may vary without restriction so long as the inter-slot spacing and slot length-to-overall-unit-height ratio is maintained. More specifically, all units have a dimensional height which is either one unit high or half of this unit high. The basic unit's height is a fixed unit height; in a preferred embodiment, the slot length is ¼ the length of the fixed unit height. The capping unit is half of the unit height and has slots which, in a preferred embodiment, are also ¼ the length of the fixed unit height. Regardless of the width of the unit, each slot is always the same distance from its neighbors as any other slot is from its immediate neighbors. The slots on one edge of the basic and multiples units have matching slots on the opposite edge, also located a fixed distance apart along the width of the unit. These slots on opposite sides of the units are thus in-line with one another.

It is also understood and appreciated that the illustrated sample configurations shown in the figures represented herein are only sample configurations, and that infinitely expandable variations of assemblies are possible by alternating use of the structural unit pieces with each slot interconnecting with the slot of another structural unit piece. Thus, the height, width and length of the volumetric partition wall or other modular structure can be expanded in height, width and length.

The Basic Unit

A preferred basic structural unit that is slotted and interlocked with other units in an assembly of the invention is depicted in Fig. 1A. Basic unit 1 has two parallel sides 6, 7 which are equal in length and two parallel sides between comers 2 and 3 and between comers 4 and 5 which are equal in length. The overall shape of unit 1 is preferably rectangular or square but could take on other forms consistent with the geometrical requirements of the invention. The height of basic unit 1 is equal to the length of sides 6 and 7.

Basic unit 1 has two slots 8 and 9 with openings along one side between comers 2 and 3 and two slots 10 and 11 along a corresponding parallel side with openings between comers 4 and 5. Each slot has a slot opening and a slot end and a fixed slot length equal to one fourth the length of sides 6 and 7. The relationship between the length of parallel sides 6 and 7 and the lengths of slots 8, 9, 10, and 11 is a fixed relationship; in other words, the length of slots 8, 9, 10 and 11 are all equal and equivalent to one-quarter the length of sides 6 and 7. Slot 8 has a slot opening 12 which has an equal width as slot end 16. Slot 9 has a slot opening 13 which has an equal width as slot end 17. Slot 10 has a slot opening 14 which has an equal width as slot end 18. Slot 11 has a slot opening 15 which has an equal width as slot end 19. The width of slots 8, 9, 10, and 11 is slightly more than the thickness of basic unit 1, reflected in the perspective drawing of FIG. 1B. The close relationship between slot width and basic unit thickness enables the units to fit snugly into the slots so as to remain in position yet be removable.

Slots 8 and 10 both run along slot axis 20. Slots 9 and 11 both run along slot axis 21. Slot axis 20 and slot axis 21 are both parallel to basic unit sides 6 and 7. The distance between slot axis 20 and 21 is a fixed distance. The distance across the basic unit between slots 8 and 9 is equal to the distance between slots 10 and 11. In the example of basic unit 1 the distance between the pairs of in-line slots is shown as less than the height of the unit; however, this relationship is merely representative of one possible configuration of basic unit 1 and need not be the case in all possible configurations of basic unit 1. For instance, the distance between the pairs of in-line slots could also be greater than the height of the units in alternative configurations.

In an alternative embodiment, the length of the slots is less than one quarter the height of the basic unit. In such case, an assembly of such basic units (as well as of multiples and corresponding capping units), provides for interlocking of the units, but adjacent units do not meet end-to-end.

Fig. 1A is shown with an optional cut-away 22 and an optional cut-away 23. Such a cut-away is a removed portion of the material of basic unit 1 which allows for the creation of voids in the assembly. Such voids are optional and allow light to pass through the assembly and may also enhance its visual appeal. The assembly can include any of these openings or voids or can have no openings or voids.

Basic unit 1 may be lasercut, handcut or stamped out of a planar flat material or formed into shape from any moldable material than can be fashioned into a flat planar surface with a desired thickness. The preferred embodiment is lasercut out of stock sheets of flat planar material. This method of construction could vary according to the type of material utilized. The slots of the basic unit are lasercut out of the sheet material. They could alternately be formed by routing out the slot material using a machine router or they could be cut out by hand using a conventional band saw.

Although the preferred embodiment is made of luan plywood, the basic, multiples, and capping units could be made of any suitable material of construction including plastics, wood, metals, fiberboard, masonite, corkboard, cardboard, resin, rubber, foam, textiles, etc.

Reflecting one embodiment of the invention, the assembly was constructed of luan plywood of nominal thickness of ⅛″, equal to approximately 3/32″ actual thickness (0.09375″). Basic unit 1 measured 6 ⅝″ from corner 2 to corner 3 and sides 6 and 7 are 7 ⅞″ high. Slots 8, 9, 10 and 11 were cut with a slot length equal to one quarter the length of the sides, or 1 31/32″ long. The slot width utilized in this embodiment was 0.0989″. The distance between the pairs of in-line slots was equal to 5.1405″. The dimensions utilized in this particular instance were only representative and may be altered so long as the aforementioned relationships are preserved.

The Multiples Unit

A representative example of the multiples unit that can be slotted and interlocked with other units in an assembly of the invention is depicted in FIG. 2A. Multiples unit 25 has two parallel sides 30, 31 which are equal in length and two parallel sides between corners 26, 27 and between corners 28, 29 which are equal in length. The overall shape of unit 25 is rectangular or square but could take on other forms consistent with the geometrical requirements of the invention. The height of multiples unit 25 is equal to the length of sides 30, 31.

Multiples unit 25 has three slots 32, 33, and 34 with openings along one side between comers 26, 27 and three slots 35, 36, and 37 along a corresponding parallel side with openings between comers 28, 29. Each slot has a slot opening and a slot end and a fixed slot length equal to one fourth the length of sides 30 and 31. The relationship between the length of parallel sides 30 and 31 and the lengths of slots 32, 33, 34, 35, 36 and 37 is a fixed relationship; in other words, the length of slots 32, 33, 34, 35, 36 and 37 are all equal and equivalent to one-quarter the length of sides 30 and 31. The height of this multiples unit is also equal to the height of the basic unit shown in Fig. 1A. The length of slots 32, 33, 34, 35, 36 and 37 is also equal to the length of slots 8, 9, 10, and 11 of unit 1 shown in Fig. 1A. Slot 32 has a slot opening 38 which is an equal width with slot end 44. Slot 33 has a slot opening 38 which is an equal width with slot end 45. Slot 34 has a slot opening 40 which is an equal width with slot end 46. Slot 35 has a slot opening 41 which has an equal width as slot end 47. Slot 36 has a slot opening 42 which has an equal width as slot end 48. Slot 37 has a slot opening 43 which has an equal width as slot end 49. The width of the slots is slightly more than the thickness of multiples unit 25, reflected in the perspective drawing of FIG. 2B. The close relationship between slot width and multiples unit thickness enables the units to fit snugly into the slots of both representative basic unit 1 and representative multiples unit 25 so as to remain in position yet be removable.

Slots 32 and 35 both run along slot axis 50. Slots 33 and 36 both run along slot axis 51. Slots 34 and 37 both run along slot axis 52. Slot axis 50, slot axis 51, and slot axis 52 are all parallel to each other and parallel to sides 30 and 31. The distance between slot axis 50 and 51 is a fixed distance. The distance between slot axis 51 and 52 is also a fixed distance and is equal to the distance between slot axis 50 and 51. This distance between neighboring slot axes in multiples unit 25 may or may not be the same as the distance between neighboring slot axes in basic unit 1. Therefore, the distance between slots 32 and 33 is equal to the distance between slots 35 and 36 and the distance between slots 33 and 34 is equal to the distance between slots 36 and 37. These distances may or may not be equal to the distance between slots 8 and 9 and between slots 10 and 11 of basic unit 1. As in the case of the basic unit, the distance between adjacent slots is shown as less than the height of the unit; however, this relationship is merely representative of a possible configuration for multiples unit 25 and need not be the case in all possible configurations of multiples unit 25. Specifically, the distance between adjacent slots could be greater than the height of the unit in alternative configurations. However, the equivalence of (1) the inter-slot distances and (2) the heights of both basic units and multiples units enables the basic unit and multiples unit to fit together in an expandable and variable manner.

FIG. 2A is shown with optional cutaways 53, 54, 55, and 56. Such cutaways are removed portions of the material of multiples unit 25 which allow for the creation of voids in the assembly. Such voids are optional and allow light to pass through the assembled construction. The assembly can include any of these openings or voids or can have no openings or voids.

Reflecting one embodiment of the invention, multiples unit 25 was constructed of luan plywood of nominal thickness of ⅛″ equal to approximately 3/32″ actual thickness. Multiples unit 25 was 11 ¾″ from corner 26 to corner 27 and sides 30 and 31 were 7 ⅞″ high. Slots 32, 33, 34, 35, 36, and 37 were 1 31/32″ long. The slot width utilized in this embodiment was 0.0989″. The inter-slot distance was equal to 5.1405″. As in the case of basic unit 1, the dimensions utilized in this particular instance are only representative and may be altered so long as the aforementioned relationships are preserved.

The Capping Unit

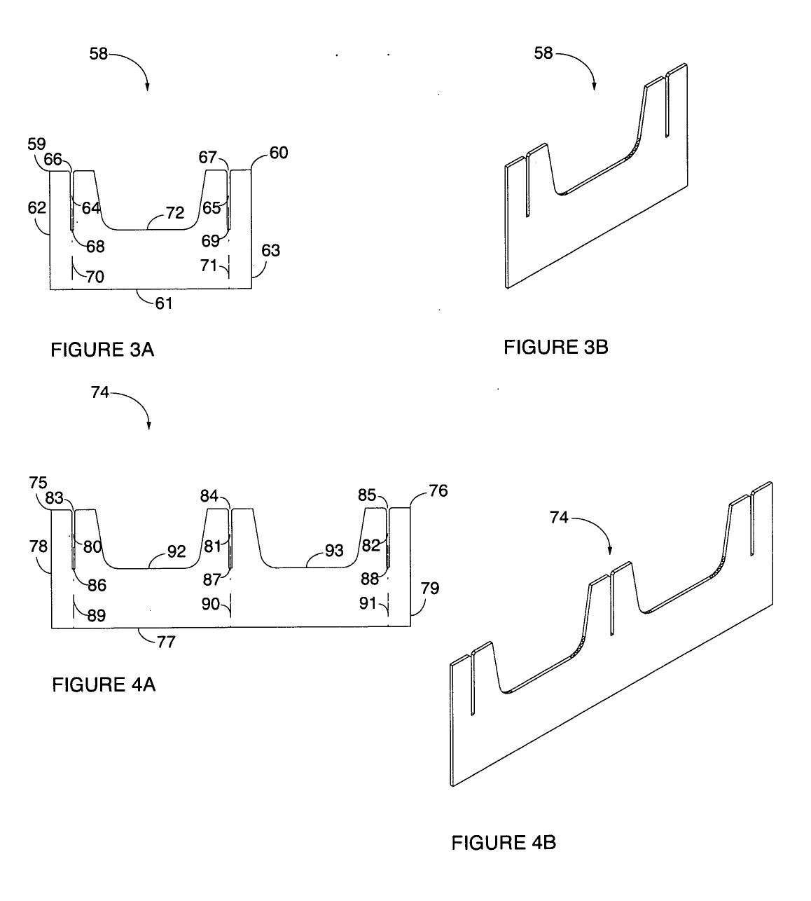

The invention may also incorporate capping units which function as terminating pieces at the ends of the assembly to effectively hide unused slots. These capping units are placed at the termination points of the assembly in order to fit into any slots that are not used to connect to adjacent units. These units may be used in a preferred embodiment of the invention but are not structurally required for an assembly to be created. FIG. 3A depicts an exemplary capping unit. This capping unit 58 is exactly half the dimensional height of the basic unit as exhibited by the length of sides 62 and 63, which are equal to half the length of sides 6 and 7 of FIG. 1A. As shown in FIG. 3A, the capping unit 58 has two parallel sides 62, 63 which are equal in length and two parallel sides (the side between comers 59 and 60 and the side 61) which are equal in length. The overall shape of unit 58 is rectangular or square but could take on other forms consistent with the geometric requirements of the invention.

Capping unit 58 has two slots 64 and 65 along only one side between comers 59 and 60. Each slot is characterized by a slot opening and a slot end. In such an embodiment, the relationship between parallel sides 62, 63 and slot length of slots 64, 65 is a fixed relationship which is related to the height of the basic unit as delineated by the length of sides 6 and 7 as shown in FIG. 1A and the height of the multiples unit as delineated by the length of sides 30 and 31 as shown in FIG. 2A; in other words, the length of slots 64 and 65 are all equal and equivalent to half the length of sides 62, 63 and the height of capping unit 58 or the length of sides 62, 63 is half the basic unit height of sides 6 and 7 in Fig. 1A and half the multiples unit height as delineated by sides 30 and 31 in FIG. 2A. The length of slots 64 and 65 are also equal to the length of slots 8, 9, 10, and 11 of unit 1 as shown in Fig. 1A and slots 32, 33, 34, 35, 36, and 37 of unit 25 as shown in FIG. 2A. Slot 64 has a slot opening 66 which is an equal width with slot end 68. Slot 65 has a slot opening 67 which is an equal width with slot end 69. The slot width is slightly more than the thickness of capping unit 58 as shown in FIG. 3B. The relationship between slot width and capping unit thickness enables the units to fit snugly into the slots of both representative basic unit 1 and representative multiples unit 25 so as to remain in position yet be removable.

Slot 64 runs along slot axis 70. Slot 65 runs along slot axis 71. Slot axis 70 and slot axis 71 are both parallel to capping unit sides 62 and 63. The distance between slot axis 70 and 71 is a fixed distance. This distance is equal to the distance between slot axis 20 and 21 in basic unit 1 as shown in FIG. 1A or equal to the distance between slot axis 50 and 51 and the distance between slot axis 51 and 52 in multiples unit 25 as shown in FIG. 2A. In one example of capping unit 58, the distance between slot axis 70 and 71 is shown as less than the length of the basic unit height as delineated by the length of sides 6 and 7 in FIG. 1A; however, this relationship is merely representative of the possible configurations of capping unit 58 and need not be the case in all possible configurations of capping unit 58. For instance, the distance between slot axis 70 and 71 as shown in FIG. 3A could also be greater than the basic unit height as delineated by the length of sides 6 and 7 in FIG. 1A in a possible configuration.

FIG. 3A shows capping unit 58 with an optional cutaway 72. Such a cut-away is a removed portion from the material of capping unit 3A which allows for the creation of voids. Such voids are not a necessary part of the invention but allow light to pass through the assembled construction. The invention could include any of these openings or voids or could have no openings or voids such as shown by cut-away 72. In a preferred embodiment the distance between cutaway 72 and the line connecting corners 59 and 60 is equal to the slot length. This is a representative cutaway and neither the dimensions, shape or existence of a cutaway of any of the units is fixed.

One embodiment of the representative capping unit was constructed of luan plywood of nominal thickness of ⅛″, or equal to approximately 3/32″ thickness. In the instance of capping unit 58 the distance between comer 59 and comer 60 was 6 ⅝″ and was equal to side 61. Sides 62 and 63 were 3 15/16″ high which was equal to half the basic unit height or half of the length of sides 6 and 7 as shown in FIG. 1 A. Slots 64 and 65 were cut at a slot length equal to one fourth the length of the basic unit height or 1 31/32″ long. The slot width utilized in the preferred embodiment was 0.0989″. In the case of the preferred embodiment, the distance between slot axis 70 and 71 was equal to 5.1405″. The sizes of construction utilized in this particular instance are only representative sizes and may be altered so long as the relationship between slot length and unit height is preserved. The distance between slot axis such as here between slot axis 70 and 71 and the basic unit height do not have a specific relationship to each other.

The structural units of the invention may be assembled to form a wide variety of modular structures, including walls, cylinders, table-type structures, etc.

FIG. 4A is exemplary of a capping unit having a relationship between sides and overall shape similar to that described in multiples unit 25 shown in FIG. 2A. In particular, this exemplary capping unit 74 bears the same unit width as the unit width of multiples unit 25 which is equal to the distance between comers 75 and 76 or the length of side 77. The thickness of capping unit 74 as shown in FIG. 4B is equal to the thickness of unit 58 as shown in FIG. 3B and also equal to the thickness of both basic and multiples units shown in FIGS. 1B and 2B.

The slots 80, 81, and 82 have common dimensions (openings, ends, widths, and lengths) as slots 32, 33 and 34 in multiples unit 25 of FIG. 2A as well as slots 35, 36, and 37 in multiples unit 25. FIG. 4A shows capping unit 74 with optional cutaways 92 and 93. These cutaways are similar in size and location in relationship to the overall capping unit as is cutaway 72 to capping unit 58 as shown in FIG. 3A.

A representative capping unit 74 was constructed of luan plywood of nominal thickness of ⅛″, or equal to approximately 3/32″ thickness. The unit width equal to side 77 was equal to 11 ¾″ and the unit height was 3 15/16″ high. Slot lengths and widths were equal to those as described in Fig. 1A, 2A and 3A.

Assembly of the Invention

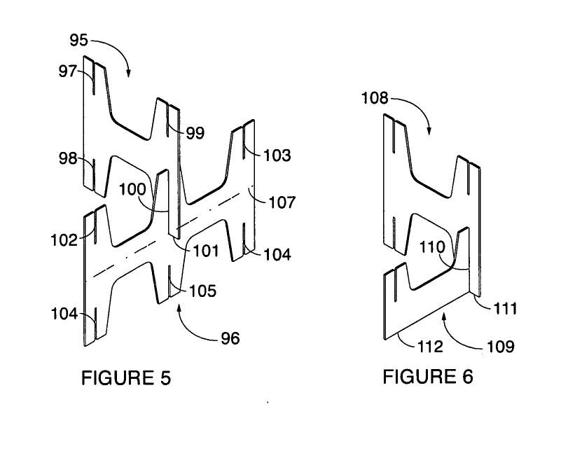

FIG. 5 depicts the interlocking of two exemplary units, in this case basic unit 95 and multiples unit 96. The two units interlock at the slot intersection shown along the edge of slot 100 shown in FIG. 5. At this point of interlocking, a slot of unit 95 is substantially filled by the thickness of the material of multiples unit 96 and a slot from unit 96 is substantially filled by the thickness of the material of basic unit 95. As a result of the interlock, edge 101 of basic unit 95 reaches the midpoint of the height of its intersecting unit, in this case along the axis 107 which is halfway up the height of multiples unit 96. As a result of such slot interlocking, the addition of yet another unit with a slot interlock at slot 105 of unit 95 would result in edges of the two units meeting along the axis 107 of unit 96. In the example of basic unit 95, slots 97, 98, and 99 are each able to interlock with a slot of another unit. Likewise, in the case of multiples unit 96, slots 102, 103, 104, and 105 are each able to interlock with a slot of another unit. Thus, each unit can be connected and secured to additional units enabling the assembly in three dimensions and the construction of the assembly through the interlocking slot method. The units to be added may be basic units, any type of multiples unit, as well as capping units. The orientation of interlock is always aligned with the slot axes shown in previous figures describing the various units of the invention.

FIG. 6 depicts the interlocking of two members, in this case basic unit 108 and capping unit 109. The two units interlock at the slot intersection shown along the edge of slot 110, as shown in FIG. 6. As a result of the interlock, the edge 111 of basic unit 108 extends to meet the edge 112 of capping unit 109. As shown in FIG. 5, each unit can be connected and secured to additional units by means of receiving additional interlocking units wherever an open slot is located.

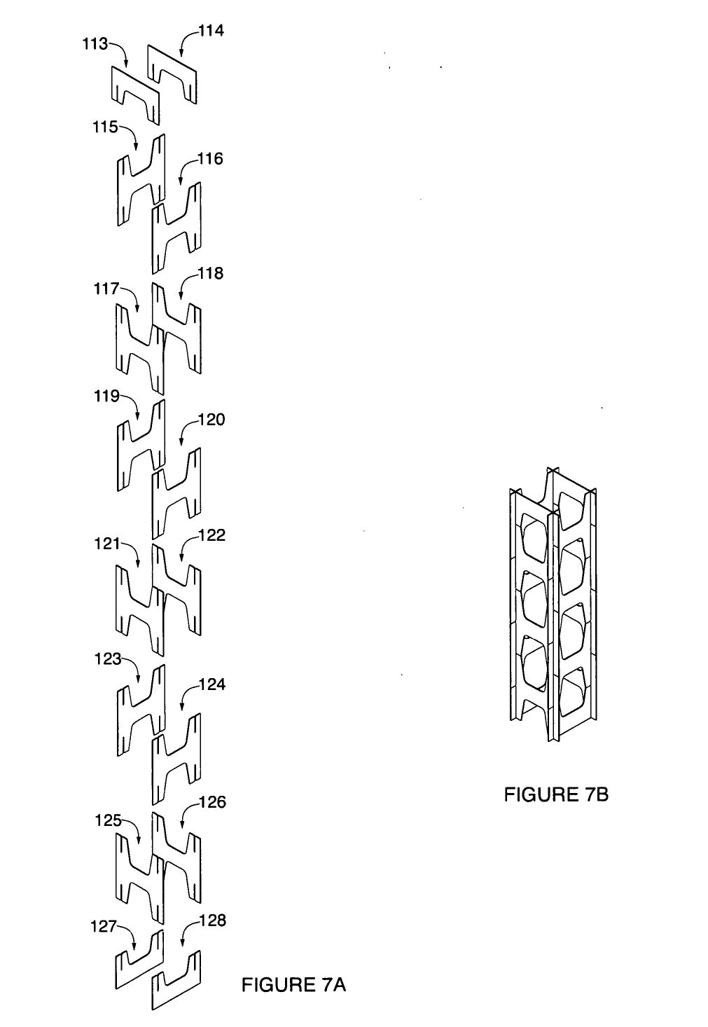

In FIG. 7A, capping units 113, 114, 127, and 128 and basic units 115, 116, 117, 118, 119, 120, 121, 122, 123, 124, 125, and 126 are shown in perspective view and in approximate relationship to each other so as to allow interlocking together via the interlocking slot method of the present invention. The units shown in FIG. 7A can be interlocked along their corresponding slot axes and upon interlocking would form the assembly of parts shown in FIG. 7B in accordance with the present invention. Such assembly is merely representative of a configuration of basic units with auxiliary capping units at the top and bottom of the assembly.

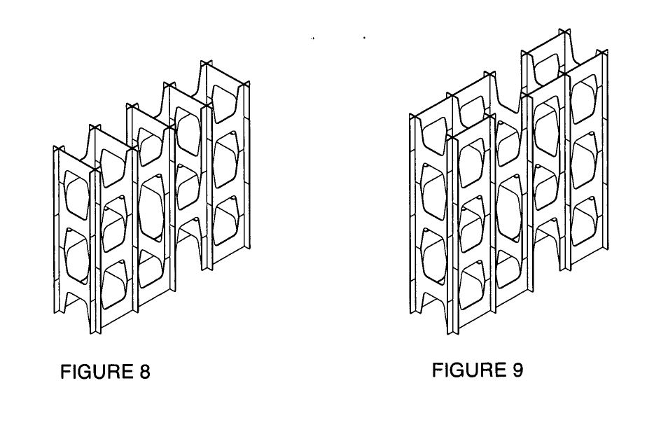

FIG. 8 and FIG. 9 depict two exemplary assemblies which illustrate the expandable nature of the present invention in one direction, in particular the means by which the height of the assembly depends on the number of units employed. FIG. 8 depicts two basic or multiples units in the vertical dimension, with the addition of one capping unit. In the alternate embodiment shown in FIG. 9, the assembly again depicts two basic or multiples units in the vertical dimension, but adds two capping units instead of one. The overall height of the assembly of FIG. 9 is equal to two full unit height levels plus two capping unit heights, for an effective total of three unit height levels. The sample configurations in FIGS. 8 and 9 can both be expanded in height, width, and length by the replacement of a basic unit in the assembly with a multiples unit. Likewise, the replacement of a capping unit having two slots with a capping unit having three slots would also result in the expansion of the assembly by providing an interconnected and open slot to which additional units can be interlocked.

The structural units of the invention may be assembled to form a wide variety of modular structures, including walls, cylinders, and table-type structures. Walls of varying height, width and length can be assembled through the use of multiples units combined with basic units. Cylinders of varying height, width and length can also be assembled by utilizing only basic units on the interior surface of the cylindrical wall. Both basic and multiples units of varying lengths can be used on the outer surface of the cylindrical wall, and the width of the cylindrical wall itself can be determined by the use of only basic units, only multiples units, or combinations of basic and multiples units in order to allow for expansion. Table-type structures can be assembled by expanding the assembly in three directions while maintaining multiple levels in limited and consistent areas.

FIGS. 10A, 10B, 10C and 10D depict stages in the assembly of a sample configuration of units wherein the units are interconnected to form a partition with a corner. FIG. 10C depicts perspective views of capping units prior to their interlocking attachment to the assembly. FIG. 10D shows the completed assembly at a representative height of three unit height levels plus one capping unit height level, or three-and-a-half unit height levels.

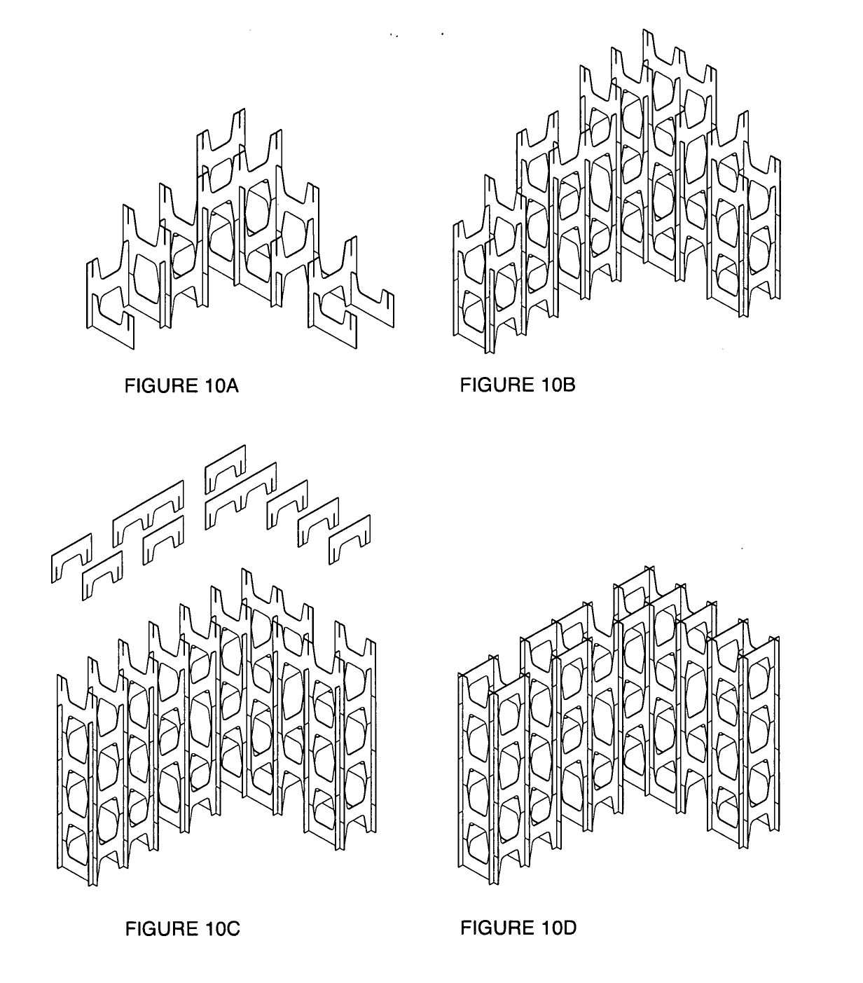

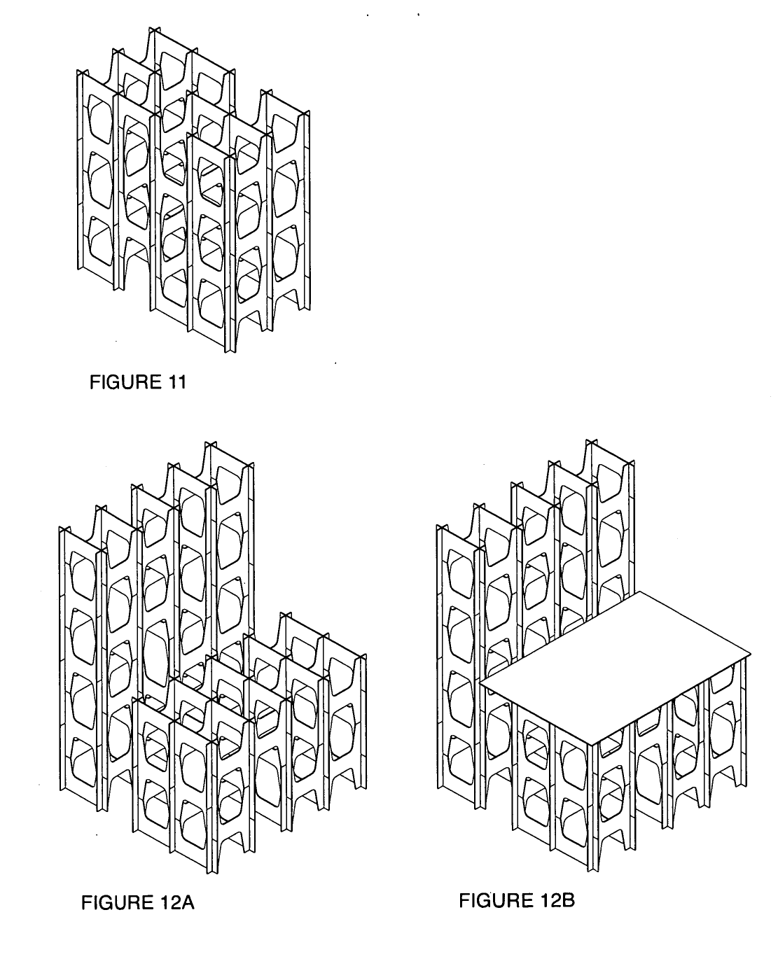

FIG. 11 is exemplary of an alternate embodiment which reveals the ability to expand an assembly of the present invention in two directions, enabling an assembly which is equal to the width of a multiples unit in comparison to the representative assemblies shown in FIGS. 8, 9, 10A, 10B, 10C and 10D which all have an overall assembly width or partition wall width of one basic unit. The assembly represented in FIG. 11 could be expanded yet further in height, width and length. In particular the width of the overall assembly could be expanded by the replacement of any multiples unit with one basic unit plus one multiples unit in the corresponding slots vacated by the original multiples unit. Thereby, additional open slots would remain which would provide open slots to which additional units can be interlocked.

FIG. 12A and FIG. 12B depict the capability of an assembly of the present invention to provide weight-bearing support so as to allow for the placement of some type of planar top surface along the horizontal boundary suggested by the assembled configuration. The planar surface depicted in FIG. 12B is not a particular aspect of the present invention but rather suggestive of the possibilities of utilizing planar materials in conjunction with the present invention.

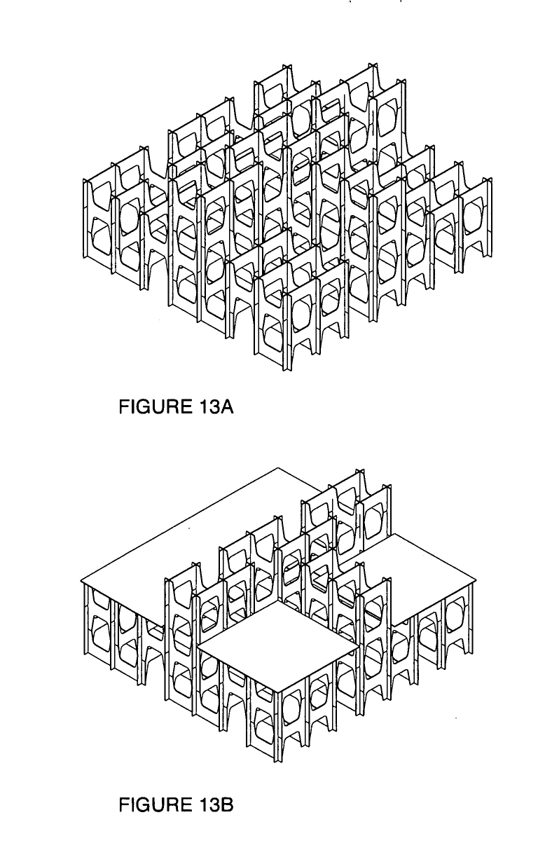

FIG. 13A and FIG. 13B are exemplary of an alternate embodiment that depicts the capability of the present invention to provide structural support so as to allow for the placement of planar surfaces along and on top of the horizontal boundary suggested by the assembled configuration. In the case of the sample configuration shown in FIG. 13A and FIG. 13B, three separate planar areas are defined by the assembly configuration which are all separated by an elevated region of assembled units which in this embodiment form a divider wall segment which is a thickness equal to one basic unit.

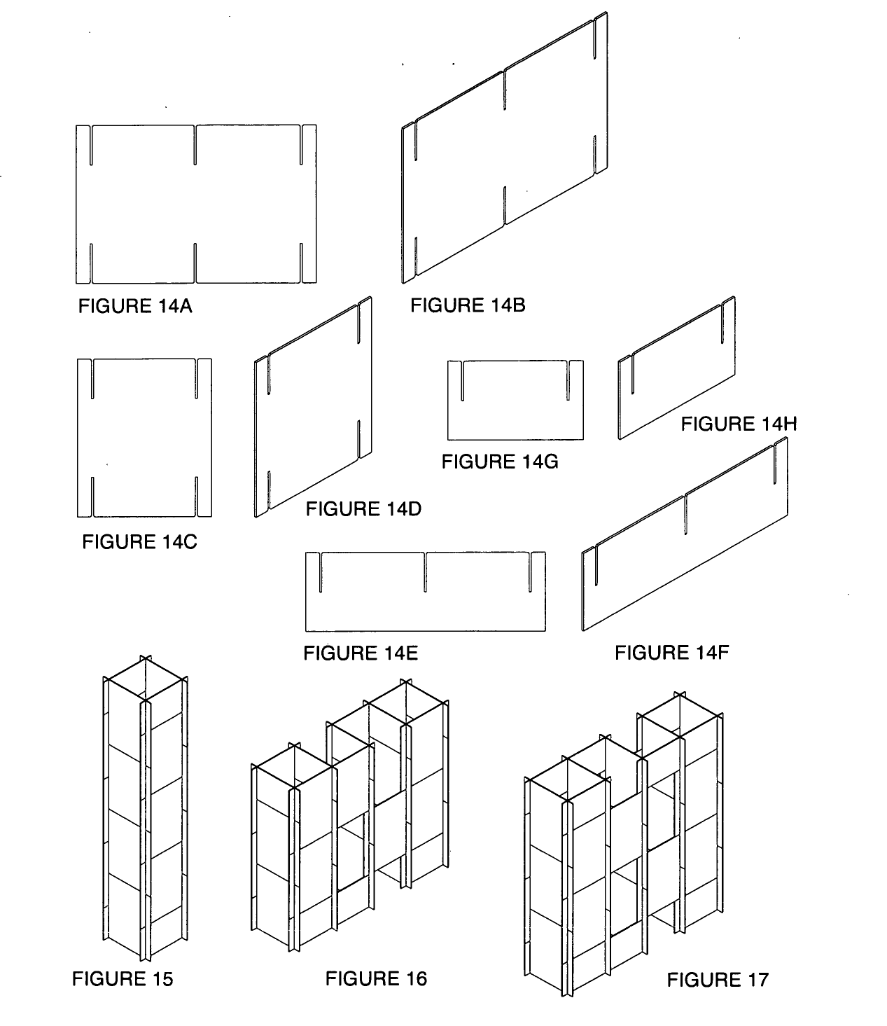

FIGS. 14A, 14B, 14C, 14D, 14E, 14F, 14G, and 14H depict a still further alternate embodiment of the present invention which is generally similar to the representative embodiment depicted previously, except that the optional cutaways are not implemented and no additional material is removed from either the basic units, the multiples units, or the capping units. The interlocking slot method operates in the same manner as previously described, with the same corresponding relationships between slot openings, slot ends, slot widths, slot lengths, slot axes and unit width, height, and thickness. The representative sample embodiment of the invention is herein depicted to suggest the many and varied configurations of alternate embodiments which are in keeping with the spirit and scope of the present invention.

FIG. 15, FIG. 16 and FIG. 17 depict sample assemblies of an embodiment and suggest some of the possible configurations in accordance with the present invention. As suggested by the alternate embodiment shown here, the optional cutaway provided in other configurations of the present invention could take on the form of a variety of cutaways including differently sized cutaways, differently shaped cutaways, cutaways in various numbers, and in the case of FIGS. 14, 15 and 16, no cutaway at all. The present invention can be produced in various embodiments so long as the preferred and corresponding relationship between slots and slot dimensions is consistent with the requirements of the embodiment of the invention as disclosed herein above.

What is claimed is:

1. A collection of structural planar units comprising:
a plurality of units each having one pair of parallel in-line slots on each of two opposite sides of the unit,
wherein the height of the units is the same,
wherein the slots in the units are of the same length and are equal to one-quarter of the height of the units, and
wherein the units may be interlocked using said slots to form an assembly.

2. The collection of structural planar units of claim 1 wherein the distance between the slots is the same among the plurality of units.

3. The collection of structural planar units of claim 1 wherein the units contain cut-outs that form openings in the assembly.

4. The collection of structural planar units of claim 1 wherein the assembly is a partition wall.

5. The collection of structural planar units of claim 1 wherein the assembly is a support structure.

6. A collection of structural planar units comprising:
a first plurality of units each having one pair of parallel in-line slots on each of two opposite sides of each unit, and
a second plurality of units having three or more pairs of parallel in-line slots,
wherein the height of the units of the first plurality of units and the second plurality of units is the same,
wherein the slots in all of the units are of a common length equal to one-quarter of the height of the units of the first or second sets of units, and
wherein the units may be interlocked using said slots to form an assembly.

7. The collection of structural planar units of claim 6 wherein the distance between the slots of the first plurality of units is the same and the distance between the slots of the second plurality of units is the same.

8. The collection of structural planar units of claim 6 wherein the units contain cut- outs that form openings in the assembly.

9. The collection of structural planar units of claim 6 wherein the assembly is a partition wall.

10. The collection of structural planar units of claim 6 wherein the assembly is a support structure.

11. A collection of structural planar units comprising:
a first plurality of units each having one pair of parallel in-line slots on each of two opposite sides of each unit,
a second plurality of units having three or more pairs of parallel in-line slots, and
a third plurality of units having two or more slots on one side of each unit,
wherein the height of the units of the first plurality of units and the second plurality of units is the same,
wherein the height of the units of the third plurality of units is one half the height of the units of the first and second plurality of units,
wherein the slots in all of the units are of a common length equal to one-quarter of the height of the units of the first or second sets of units, and
wherein the units may be interlocked using said slots to form an assembly.

12. The collection of structural planar units of claim 11 wherein the distance between the slots of the first plurality of units is the same, the distance between the slots of the second plurality of units is the same, and the distance between the slots of the third plurality of units is the same.

13. The collection of structural planar units of claim 11 wherein the units contain cut-outs that form openings in the assembly.

14. The collection of structural planar units of claim 11 wherein the assembly is a partition wall.

15. The collection of structural planar units of claim 11 wherein the assembly is a support structure.

16. A method of assembling a collection of structural planar units comprising the steps of:
interlocking two structural planar units from among a set comprised of a first plurality of structural planar units, a second plurality of structural planar units, and a third plurality of structural planar units,
wherein said first plurality of structural planar units each have one pair of parallel in-line slots on each of two opposite sides of each unit,
wherein said second plurality of structural planar units each three or more pairs of parallel in-line slots,
wherein said third plurality of structural planar units each have two or more slots on one side of each unit,
wherein the height of the units of the first plurality of units and the second plurality of units is the same,
wherein the height of the units of the third plurality of units is one half the height of the units of the first and second plurality of units,
wherein the slots in all of the units are of a common length equal to one-quarter of the height of the units of the first or second sets of units, and
continuing to interlock additional units from among the set thereby forming an assembly.

17. The method of claim 16 wherein the units contain cut-outs that form openings in the assembly.

18. The method of claim 16 wherein the assembly is a partition wall.

19. The method of claim 16 wherein the assembly is a support wall.

20. The method of claim 16 wherein the additional units are interlocked until no unused slots remain.
